(19) United States
(12) Patent Application Publication
(10) Pub. No.: US 2007/0278241 A1
(43) Pub. Date: Dec. 6, 2007

(54) DISPENSER FOR HYGIENE PAPER ROLLS

(75) Inventors: Asa JONSSON, Lidkoping (SE); Maria GINK, Goteborg (SE)

Correspondence Address: YOUNG & THOMPSON, 745 SOUTH 23RD STREET, 2ND FLOOR, ARLINGTON, VA, 22202, US

(73) Assignee: SCA HYGIENE PRODUCTS AB, Goteborg (SE)

(21) Appl. No.: 11/840,391

(22) Filed: Aug. 17, 2007

Related U.S. Application Data
(63) Continuation of application No. PCT/SE2005/000214, filed on Feb. 17, 2005.

(51) Int. Cl. G07F 11/72

(52) U.S. Cl. 221/30

(57) ABSTRACT

A dispenser for hygiene paper rolls includes a frame (1) for supporting a shaft (2) so arranged as to support a hygiene paper roll (R). The shaft (2) exhibits at its opposite end parts (13) hook devices (19) so arranged as to be hooked securely into the frame (1), and includes carrying devices (14) to support a hygiene paper roll. The carrying devices are capable of rotating relative to the end parts (13) containing the hook devices.

### CROSS-REFERENCE TO RELATED APPLICATION

This is a continuation of International application PCT/SE2005/000214 filed on 17 Feb. 2005, which designated the United States of America.

### FIELD OF THE INVENTION

The present invention relates to a dispenser for hygiene paper rolls comprising a frame for supporting a shaft so arranged as to support a hygiene paper roll.

### BACKGROUND OF THE INVENTION

Hygiene paper rolls are often used in workshops, catering establishments and the like for wiping up spillages of oil or other liquids on work surfaces, for cleaning of surfaces or for polishing. Hygiene paper is also used for wiping the hands. This paper is supplied in large rolls, which can have a diameter and a width of about 400 mm. The hygiene paper rolls are supported by dispensers in the form of floor-mounted or wall-mounted stands. The shaft which supports the rolls in these stands often consists of a tube or similar, on which two sleeves so arranged as to fit in the central holes of the rolls are arranged in such a way as to be capable of displacement. This shaft is mounted at its ends in such a way as to be capable of being lifted into and out of the frame of the wall-mounted or floor-mounted stand. The shaft with a roll introduced onto it can have a weight of about 10 kg, and it has been found that this can present problems when putting the shaft with a roll introduced onto it in place on the floor-mounted or wall-mounted stand.

The object of the present invention is to make available a dispenser for hygiene paper rolls, in which the shaft supporting the roll can be easily lifted off and put in place.

### SUMMARY OF THE INVENTION

This object is achieved by means of a dispenser for hygiene paper rolls comprising a frame for supporting a shaft so arranged as to support a roll of hygiene paper, characterized in that the shaft exhibits at its opposite end parts hook devices so arranged as to be hooked securely into the frame, and in that the shaft comprises carrying devices to support a hygiene paper roll, which carrying devices are capable of rotating relative to the end parts containing the hook devices.

In a preferred embodiment, the hook devices are U-shaped with an upper part and two legs, which extend downwards from the upper part and perpendicularly to the latter, and the frame has recesses, which permit the introduction of the hook devices, and has a lower edge, onto which the hook devices can be hooked securely so that the underside of the upper part of the hook device is in contact with the lower edge of the recess, and the legs of the hook device extend downwards to either side of the lower edge of the recess in the frame. The space between the legs of the hook device preferably exhibits the same form as that part of the frame with which the hook device interacts. The parts of the frame which interact with the hook devices preferably exhibit a flat form and have a rectangular cross section, the recesses in the frame are rectangular and are bounded by one upper edge, one lower edge and two lateral edges, and the width of the hook devices corresponds to the width of the recesses. The front legs of the hook devices are attached to flat sections in the end parts of the shaft and are in contact, with the shaft in the position in which it is ready for use, with flat sections in the frame. Those parts of the frame which contain the recesses which interact with the hook devices preferably extend in a plane that is inclined in relation to both a vertical plane and a horizontal plane. The end parts of the shaft moreover extend laterally beyond the outer lateral boundaries of the frame, and the parts of the end sections situated laterally outside the frame form handles. The end sections of the shaft have tubular sections in their parts opposite the handle parts, which sections are adjacent to the flat sections supporting the hook devices and are capable of being inserted into a central tube body in the shaft and are rotatable relative to the latter. Three axially facing fins preferably project out radially from the periphery of the central tube body, which fins are uniformly distributed around the circumference of the tube body.

### BRIEF DESCRIPTION OF THE DRAWINGS

The invention is described below with reference to the accompanying Figures, in which:

FIG. 1 illustrates schematically a perspective view at an angle from the front of a preferred embodiment of a dispenser in accordance with the invention;

FIG. 2 illustrates schematically a perspective view of an end section of the shaft for supporting a hygiene paper roll in the dispenser in accordance with FIG. 1;

FIG. 3 illustrates schematically the shaft in accordance with FIG. 2 supported in the frame of the dispenser;

FIG. 4 illustrates a cross-sectional view along the line IV-IV in FIG. 3; and

FIG. 5 illustrates schematically a perspective view at an angle from the front of a dispenser in accordance with a second embodiment.

### DETAILED DESCRIPTION OF THE INVENTION

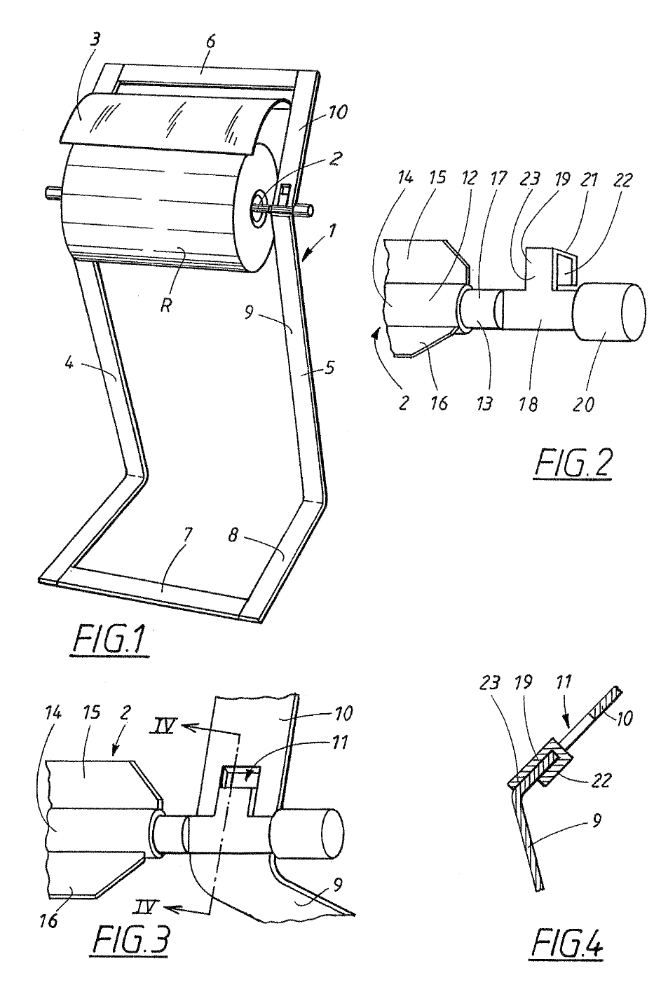

FIGS. 1-4 illustrate a dispenser in the form of a floor-mounted frame for a hygiene paper roll R. The dispenser is illustrated in FIG. 1 viewed at an angle from the front and at an angle from above. The dispenser comprises a frame 1, which supports a shaft 2, which, in a position in which it is ready for use, supports a hygiene paper roll R, and a knife 3, which, in a position in which it is ready for use, rests against the periphery of the roll R and is preferably serrated on the edge which is in contact with the roll R.

The frame 1 is constructed from two side bars 4,5, which are connected to one another at their upper and lower ends by transverse bars 6 and 7. The side bars 4,5 are identical and have a lower horizontal floor part 8, a middle part 9 and an upper part 10. The middle part 9 is inclined forwards obliquely relative to the floor part 8, and the upper part 10 is inclined backwards obliquely relative to the middle part 9. The inclination of the middle part 9 is such that a vertical plane containing the transitions of the side bars from the middle part 9 to the upper part 10 passes through the mid points of the floor parts 8 of the frame or ends slightly ahead of these points. Transcurrent rectangular holes 11 are accommodated in the upper parts 10 at a certain distance from the transitions of the side bars from the middle part 9 to the upper part 10. In the embodiment shown here, the bars of the frame have a rectangular cross section.

The shaft 2 for supporting the hygiene paper roll R has three parts, a central part 12 and two opposing end parts, of which only the right-hand end part 13 in FIG. 1 is shown in the Figures. The central shaft part 12 comprises a tube body 14 and three axially facing identical fins, which project radially outwards from the periphery of the tube body 14 and are uniformly distributed around the periphery of the tube body. Only two fins 15,16 are shown in the Figures, and the third fin is concealed in the illustrated perspective views. Each of the end parts of the shaft 2 has an inner tubular section 17 facing towards the central part 12, which tubular section is capable of being inserted into the tube body 14 in the central part 12 of the shaft 2, a middle section 18 with a hook device 19 and an outer end part 20.

The hook devices are so arranged as to be capable of being introduced into the respective recess 11 in the upper parts 10 of the frame 1 and for this purpose exhibit a U-shaped form with a flat upper part 21 and two downward-facing legs 22,23, which extend perpendicularly from the upper part 21. It should be pointed out here that position designations for the hook device, such as “upper” and “downward-facing”, relate to the situation of the hook devices in their position assembled on the frame 1. The distance between the legs corresponds to the thickness of the side bars 4,5 contained in the frame 1, and the width of the hook device 19 corresponds to the width of the recess 11 in these bars. The height of the recesses 11 is rather greater than the height of the rear leg 22 of the hook device. The inside of the leg 23 of the hook device also extends in the same plane as the rear side of the middle section 18 of the end part, which middle section has a width that is identical to or greater than the width of the side bars 4,5 of the frame. In this way, the latter middle section 18 will be in contact with the upper part 10 of the side bars of the frame when the shaft 2 is mounted on the frame 1, as illustrated in FIGS. 3 and 4.

Because the middle section 18 of the end parts of the shaft 2 extends over the width of the side bars of the frame 1, the end sections 20 will extend beyond the lateral boundaries of the frame 1 and will constitute readily graspable handles. In order to facilitate handling of the shaft 2, these handles have no sharp edges, but can consist of sections with a circular or oval cross section.

The knife 3 is pivotally mounted on a transverse shaft supported by the frame 1. In its position when folded up, the knife 3 rests against the upper transverse bar 6.

The frame 1 can be made from metal, for example stainless steel, while the shaft 2 is preferably made from a plastic material. It is possible, however, to make the frame from a plastic material, just as it is possible to make the shaft from metal. It is also possible to make the frame from wood. The parts of the shaft can also be made from different materials; for example the central part can be made from metal, while the end parts can be made from molded plastic.

It is very easy to replace the paper roll R with a new roll when it has run out. The shaft 2 is first pushed upwards until the rear leg 22 arrives on a level with or above the lower edge of the recess 11, after which the hook device 19 is lifted or rotated out of the recess and the shaft is lifted out of the frame.

A new hygiene paper roll R is then introduced onto the shaft 2. The fins on the central part 12 of the shaft 2 fit into the central hole of the roll R, and the introduction of the roll R is facilitated by the fact that the fins have tapered ends. It should be pointed out in this context that even slightly crushed rolls, i.e. slightly deformed rolls, whose center hole is no longer circular, can be introduced onto the shaft more easily thanks to the presence of the fins compared with the situation if the shaft were to have a cylindrical outer surface. After introducing the roll R onto the shaft 2, the latter is lifted up and the middle sections 18 of the end parts of the shaft 2 are placed on the upper frame parts 10. The shaft can then be pushed upwards or downwards, depending on the position of its middle sections, until the middle parts 21 of the hook devices are situated on a level with the upper edges of the recesses 11. The hook devices are then rotated into the recesses, and the shaft 2 is moved downwards so that the middle parts 21 come into contact with the lower edges of the recesses 11. Because the shaft 2 rests against the upper parts 10 of the side bars during the fitting phase of the hook devices in the recesses, a part of the weight of the shaft will be taken up by the frame, which facilitates changing a roll by persons with low physical strength.

It has been found that, in order to permit the ergonomically correct handling of the hygiene paper roll R, both during normal use and when changing a roll, the height of the shaft 2 above the floor should be about 700 mm.

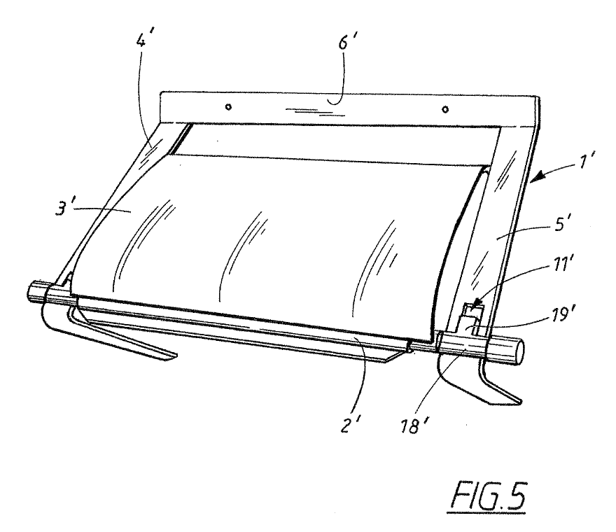

A second embodiment of a dispenser in accordance with the invention is illustrated in FIG. 5. This dispenser differs from the embodiment illustrated in FIGS. 1-4 only in that the frame 1′ is not free-standing, but is intended to be mounted on a wall. Components of this dispenser that is suitable for wall-mounting and is illustrated in FIG. 5, which correspond to similar components in the dispenser illustrated in FIGS. 1-4, have been given the same reference designations with the addition of a prime character.

The embodiments illustrated here can naturally be modified within the scope of the invention. For example, the frame bars can have cross sections other than rectangular, for example they may consist of tubes. In such cases, the hook devices and the middle sections of the end parts of the shaft supporting the hook devices should also be given a form corresponding to the form of the frame bars in order to make contact with the frame bars over their entire lateral extent. The recesses may also have a different form, for example they may be broader at the top edge than at the bottom edge, in order to facilitate the introduction of the hook devices into the recesses. The end parts of the shaft can also comprise bearings or friction-reducing coatings in those parts thereof that are inserted into the central tube body of the shaft. The tubular sections of the end parts of the shaft can also extend to the middle of the central tube body inside the latter, and they can also be attached to one another, for example by means of interacting threaded parts. The end parts of the shaft can comprise projections or beads to prevent lateral movements between the end parts and the central part in the position in which it is ready for use. Such projections or beads can be so arranged as to interact with the ends of the central tube body or with notches or recesses on the inside of the tube body. The frame can also have a different form and can be constructed in a different way than in the embodiments shown here. The end sections of the end parts that form handles can also have cross-sectional forms other than circular or oval forms, for example they may have triangular forms with rounded edges. The scope of the invention must accordingly be restricted only by the content of the accompanying Patent Claims.

1. A dispenser for hygiene paper rolls comprising: a frame for supporting a shaft so arranged as to support a hygiene paper roll, wherein the shaft exhibits at its opposite end parts hook devices so arranged as to be hooked securely into the frame, and the shaft comprises carrying devices to support a hygiene paper roll; said carrying devices being capable of rotating relative to the end parts containing the hook devices.

2. The dispenser as claimed in claim 1, wherein the hook devices are U-shaped with an upper part and two legs, which extend downwards from the upper part and perpendicularly thereto, and the frame has recesses, which permit the introduction of the hook devices and has a lower edge, onto which the hook devices can be hooked securely so that the underside of the upper part of the hook device is in contact with the lower edge of the recess, and the legs of the hook device extend downwards to either side of the lower edge of the recess in the frame.

3. The dispenser as claimed in claim 2, wherein the space between the legs of the hook device exhibits the same form as that part of the frame with which the hook device interacts.

4. The dispenser as claimed in claim 3, wherein the parts of the frame which interact with the hook devices exhibit a flat form and have a rectangular cross section, the recesses in the frame being rectangular and being bounded by one upper edge, one lower edge and two lateral edges, and said hook devices having a width which corresponds to the width of the recesses.

5. The dispenser as claimed in claim 4, wherein the front legs of the hook devices are attached to flat sections in the end parts of the shaft and are in contact, with the shaft in the position in which it is ready for use, with flat sections in the frame.

6. The dispenser as claimed in claim 5, wherein those parts of the frame, which contain the recesses that interact with the hook devices, extend in a plane that is inclined in relation to both a vertical plane and a horizontal plane.

7. The dispenser as claimed in claim 1, wherein the end parts of the shaft extend laterally beyond the outer lateral boundaries of the frame, and the parts of the end sections situated laterally outside the frame form handles.

8. The dispenser as claimed in claim 7, wherein the end sections of the shaft have tubular sections in their parts opposite the handle parts; said tubular sections being adjacent to the flat sections supporting the hook devices and being capable of being inserted into a central tube body in the shaft and being rotatable relative to the latter.

9. The dispenser as claimed in claim 8, wherein three axially facing fins project out radially from the periphery of the central tube body; said fins being uniformly distributed around the periphery of the tube body.
